(19) United States
(12) Patent Application Publication
(10) Pub. No.: US 2002/0002503 A1
(43) Pub. Date: Jan. 3, 2002

(54) Business method by internet connection information registration service, internet connection setting method, internet connection information registration method, and computer-readable recording medium which records application program

(76) Inventor: Kenji Matsuoka, Yokohama-shi (JP)

Correspondence Address: Finnegan, Henderson, Farabow, Garrett & Dunner, L.L.P., 1300 I Street, N.W., Washington, DC, 20005-3315, US

(21) Appl. No.: 09/840,057

(22) Filed: Apr. 24, 2001

(30) Foreign Application Priority Data
Apr. 27, 2000 (JP) 2000-128220

(51) Int. Cl. H04K 1/00; H04L 9/00; G06F 17/60

(52) U.S. Cl. 705/26; 705/67; 705/76; 705/77

(57) ABSTRACT

A memory card is connected to a PC at a mass sales store, the store side makes a provider agreement for a user by exchanging information with the terminal of a provider selected by the user through a communication line by processing according to an application, information necessary for Internet connection is received from the provider terminal, and Internet connection information is generated on the basis of the information and registered on the memory card. When the memory card having the Internet connection information registered thereon is connected to an electronic device such as a PC or portable telephone, an application is automatically activated to load the Internet connection information from the memory card and execute connection setting for Internet connection in the electronic device on the basis of the information.

### BACKGROUND OF THE INVENTION

The present invention relates to a business method by an Internet connection information registration service, Internet connection setting method, Internet connection information registration method, and computer-readable recording medium which records an application program, which are suitable to implement setting for Internet connection using a portable recording medium.

In recent years, not only a personal computer (to be referred to as a PC hereinafter) but also many electronic devices, including a mobile telephone represented by a portable telephone, game apparatus, and television apparatus (to be referred to as a TV apparatus hereinafter), have a communication function, so these devices can be connected to the Internet to transmit/receive e-mail, browse a homepage, and do online shopping.

To connect an electronic device to the Internet, the user must select a desired provider (Internet connection agency), make an agreement with the provider, and acquire pieces of information (to be referred to as Internet connection information hereinafter) such as a user ID, user password, mail account, mail password, DNS (Domain Name System), and access point. The user then performs predetermined operation of setting the acquired Internet connection information to the electronic device. With the above procedure, the electronic device can be connected to the Internet.

However, the user-side setting procedure for connecting the electronic device to the Internet is not always easy for a user who has no experience on a PC or the like. Some providers distribute a free recording medium such as a CD-ROM that stores guidance software for the Internet connection information acquisition and setting operations. However, even with such a CD-ROM, the user must still do necessary setting operations in a correct order.

A certain kind of portable telephone can be connected to the Internet without any special user operation. However, for a portable telephone of this type, the provider (Internet connection agency) is fixed. Hence, some users must separately agree with a provider for Internet connection from, e.g., a PC and a provider for Internet connection from a portable telephone and separately pay basic charges.

### BRIEF SUMMARY OF THE INVENTION

The present invention has been made in consideration of the above situation, and has as its object to provide a business method by an Internet connection information registration service, which allows automatic setting for Internet connection using a portable recording medium.

It is another object of the present invention to provide an Internet connection setting method, Internet connection information registration method, and a computer-readable recording medium which records an application program, which can implement automatic setting for Internet connection using a portable recording medium.

According to the present invention, there is provided an Internet connection setting method using a portable recording medium, characterized by comprising the steps of making a provider agreement for a user by exchanging information with the terminal of an Internet provider selected by the user through a communication line at a write terminal in a store, which is capable of connecting the portable recording medium, receiving information necessary for Internet connection from the provider terminal, generating Internet connection information for Internet connection on the basis of the information and registering the Internet connection information on the portable recording medium, when the portable recording medium having the Internet connection information registered thereon is connected to an electronic device in which an application program (Internet connection setting application program) capable of automatically loading the Internet connection information is registered in advance, automatically activating the application program to load the Internet connection information from the portable recording medium and execute connection setting for Internet connection in the electronic device on the basis of the loaded Internet connection information.

In the Internet connection setting method with the above steps, not only the provider agreement with the Internet provider selected by the user can be made for the user at the write terminal in the store but also the Internet connection information for Internet connection through the provider can be registered on a portable recording medium represented by a memory card, floppy disk, or mini disk (MD). Hence, the user can cause the application program to automatically execute setting necessary for Internet connection only by connecting the medium to an electronic device such as a personal computer, portable telephone, or electronic camera (digital camera). In addition, since the medium is portable, automatic Internet connection setting can be performed in every electronic device by preparing only one medium.

To make Internet connection setting possible independently of the type of electronic device, the data structure of Internet connection information is uniformed to a predetermined data format independently of the type of electronic device. Furthermore, dialup setting is applied as Internet connection setting.

To protect the Internet information registered on the portable recording medium from illicit use by a third party, the user is caused to input an arbitrary password to the write terminal, the input password is encrypted in accordance with a predetermined algorithm, registering the encrypted password in a predetermined area of the portable recording medium, in Internet connection setting in the electronic device, the user is caused to input a password, the authenticity of the user is determined by comparing/collating the input password with the registered password on the predetermined area after decrypting the input password or encrypting the registered password by a predetermined algorithm, and Internet connection setting is executed on the basis of the determination result.

The information transferred from the write terminal to the provider selected by the user in exchanging the information comprises at least one of a method of paying a charge to the provider and a candidate of a mail account requested by the user.

For the electronic device on the user (client) side, the present invention related to the Internet connection setting method using a portable recording medium can be regarded as an invention related to an Internet connection setting method of an electronic device, or an invention related to a computer-readable recording medium which records an Internet connection setting application program (for causing the electronic device to execute procedures applied to the above method). For the write terminal in the store, the present invention can be regarded as an invention related to an Internet connection information registration method at the write terminal for the Internet connection service, or an invention related to a computer-readable recording medium which records an Internet connection information registration application program (for causing the write terminal to execute procedures applied to the above method).

When the Internet connection information registration service for a portable recording medium (presented by the user or bought by the user at the store with the write terminal installed) is executed by the write terminal, the Internet provider selected by the user is expected to benefit. For this reason, the present invention can also be regarded as an invention related to a business method by an Internet connection information registration service in which the store with the write terminal installed obtains a predetermined compensation from the provider. This can also incorporate a business mechanism wherein the developer of the Internet connection information registration service also obtains a predetermined compensation from the provider selected by the user.

To accurately calculate the compensation on the provider side, the write terminal is caused to notify an agreement count apparatus of the Internet connection information registration service developer of completion of registration of the Internet connection information on the portable recording medium whereby the agreement count apparatus counts the number of subscribers to each provider in units of stores, and the count result is periodically sent from the agreement count apparatus to a corresponding provider.

The present invention related to the Internet connection information registration method can also be regarded as an invention related to a write terminal (Internet connection information write terminal) to which the method is applied.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing the overall arrangement of an Internet connection system using a portable recording medium according to an embodiment of the present invention;

FIG. 2 is a view for explaining an Internet connection information registration service to a memory card 15 at a mass sales store 16 (Internet connection information registration service store) in the system show in FIG. 1;

FIG. 3 is a block diagram showing the schematic arrangement of the memory card 15;

FIG. 4 is a view for explaining Internet connection from a user-side electronic device (PC 11) using the memory card 15 on which Internet connection information 150 is written; and

FIG. 5 is a view for explaining cash back from each provider to the system providing company and Internet connection information registration service store.

### DETAILED DESCRIPTION OF THE INVENTION

The embodiment of the present invention will be described below with reference to the accompanying drawing.

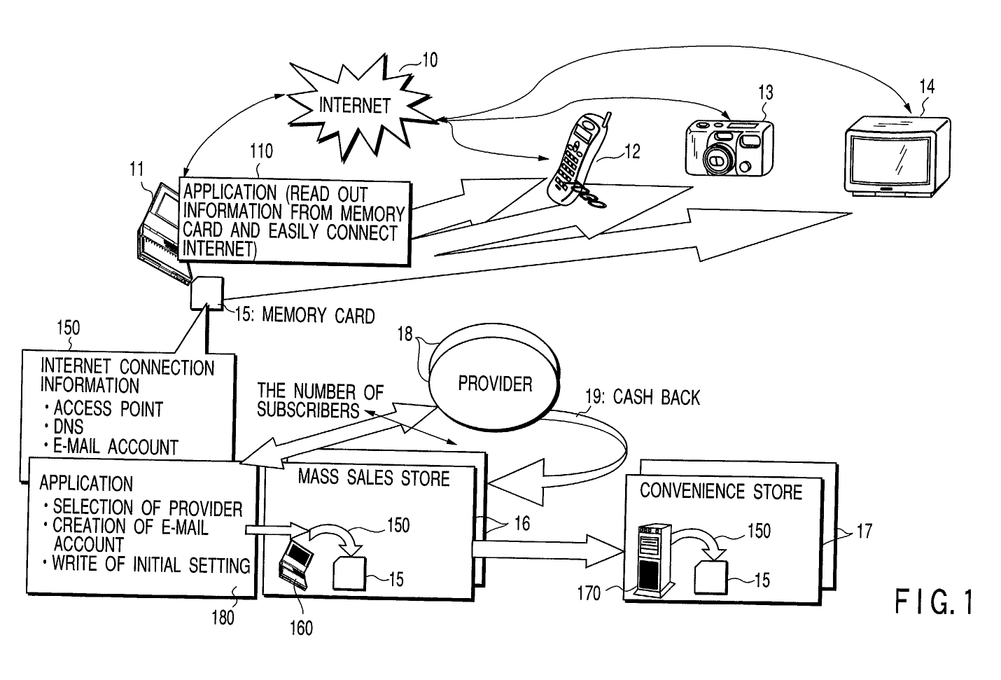

FIG. 1 is a view showing the overall arrangement of an Internet connection system using a portable recording medium according to an embodiment of the present invention.

Referring to FIG. 1, each of electronic devices such as a PC (Personal Computer) 11, portable telephone 12 as a mobile telephone, electronic camera 13, and TV apparatus (television apparatus) 14 has a card slot capable of receiving a predetermined portable recording medium, e.g., a stamp-size memory card 15 having a secret storage area which cannot be directly externally accessed, and a communication interface (not shown) such as a modem necessary for connection to the Internet 10.

In this embodiment, Internet connection information 150 containing a user ID, user password, mail account, mail password, DNS (DNS server address), and access point (telephone number of the connection destination) is registered on the memory card 15 such that the electronic device with the card 15 inserted (to the card slot) can be connected to the Internet 10 (through the server of an Internet provider, i.e., the provider side). The Internet connection information 150 registered on the memory card 15 has a predetermined data format independently of the type of the electronic device (device) such as the PC 11, portable telephone 12, electronic camera 13, or TV apparatus 14.

The PC 11 has a (computer-readable) recording medium recorded with a specific application program (Internet connection setting application program) 110 which is automatically activated when the memory card 15 is inserted into the corresponding card slot, and reads out the Internet connection information 150 having a predetermined format from the card 15 for automatic connection to the Internet 10. The electronic device of another type, such as the portable telephone 12, electronic camera 13, or TV apparatus 14, also has a (computer-readable) recording medium recorded with the Internet connection setting application program (to be referred to as an application hereinafter) 110. This recording medium is a ROM, disk device, or flash memory. The application 110 may be downloaded through a communication line.

Since the electronic device such as the PC 11, portable telephone 12, electronic camera 13, or TV apparatus 14 has the application (Internet connection setting application) 110, the user can easily connect the device to the Internet 10 only by having the memory card 15 on which the Internet connection information 150 is registered and appropriately inserting the card 15 into the card slot of the electronic device (electronic device such as the PC 11, portable telephone 12, electronic camera 13, or TV apparatus 14). The user can connect every device to the Internet 10 by selectively using the single memory card 15 because the memory card 15 does not depend on the electronic device to be used.

In this embodiment, there is a store that provides the registration service of the Internet connection information 150 onto the memory card 15. A customer takes the memory card 15 to a store of this type or buys the memory card 15 at the store and requests the store side to register the Internet connection information onto the memory card 15. Referring to FIG. 1, the Internet connection information registration service is provided by a mass sales store 16 and convenience store 17. For this purpose, the mass sales store 16 prepares a PC 160 having a (computer-readable) recording medium recorded with an application (Internet connection information registration application program) 180 for Internet connection information registration. The convenience store 17 prepares an information write terminal 170 having a (computer-readable) recording medium recorded with not only the application (Internet connection information registration application) 180 for Internet connection information registration to the memory card 15 but also an application for digital content download to the memory card 15, MD (Mini Disk), or the like.

The number of users (the number of subscribers) who have agreed with Internet providers (to be referred to as providers hereinafter) 18 as a result of the registration service at the Internet connection information registration service store such as the mass sales store 16 or convenience store 17 can be totalized in units of providers 18 and in units of Internet connection information registration service stores. Each provider 18 does cash back 19 according to the number of subscribers to the providing company of this system (Internet connection system using a portable recording medium) and the Internet connection information registration service store (mass sales store 16, convenience store 17, or the like) in units of predetermined periods, e.g., in units of months.

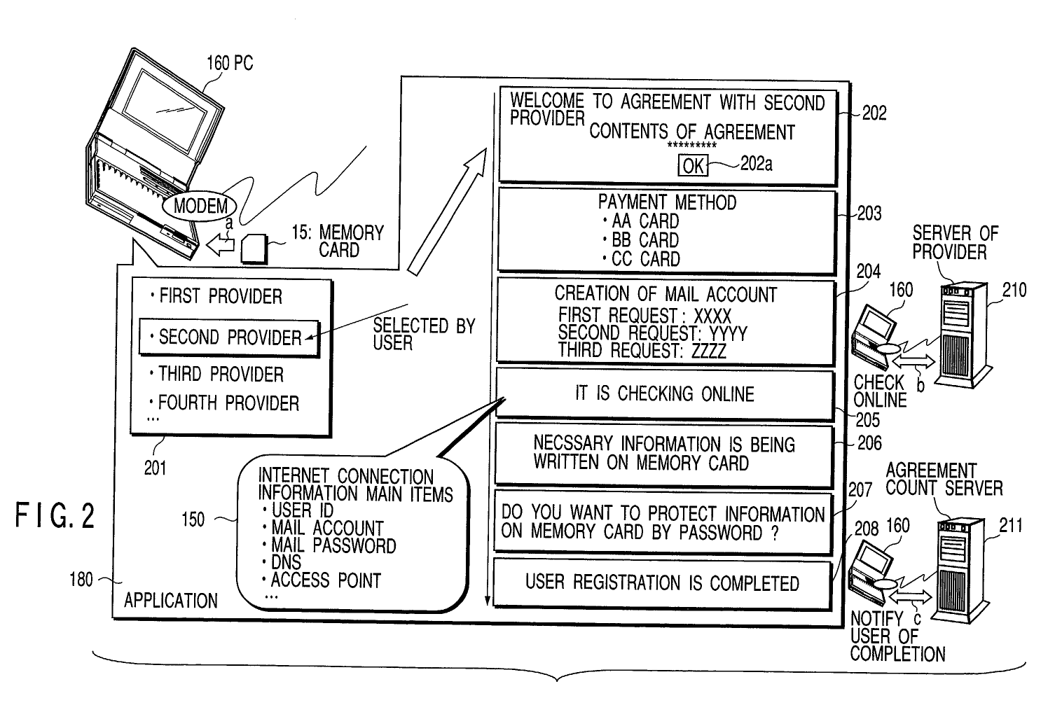

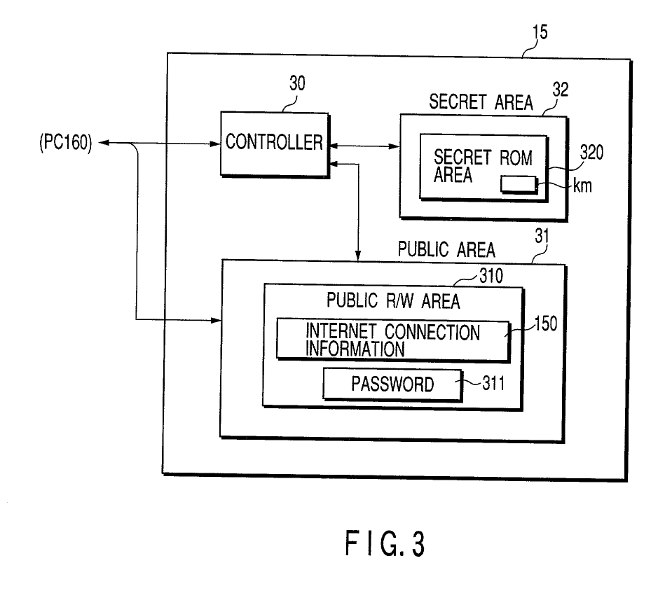

The Internet connection information registration (write) service to the memory card 15 at the Internet connection information registration service store, e.g., the mass sales store 16 in the system shown in FIG. 1 will be described next with reference to FIGS. 2 and 3.

When the user's memory card 15 is inserted to the card slot of the PC 160, as indicated by an arrow a, the Internet connection information registration application 180 is activated. A window (provider list window) 201 of providers (that have agreements with the company for providing the system shown in FIG. 1) is displayed on the display device of the PC 160.

When the user selects a desired provider or a clerk of the mass sales store 16 selects a provider requested by the user on the provider list window 201, the PC 160 displays a window 202 representing the contents of the subscriber agreement with the selected provider in accordance with the application 180. This window 202 has an OK button 202a. When the OK button 202a is clicked (selected), the window is switched to a payment method selection window 203. When a payment method is selected, the window is switched to a mail account creation window 204. When mail account candidates requested by the user are set, the PC 160 connects itself to a server 210 of the provider designated by the user through a line (Internet) and sends the payment method and mail account candidates designated by the user to the server 210, thereby requesting check, as indicated by an arrow b. Then, the window is switched to an online check window 205.

The server 210 of the provider designated by the user checks sequentially from the first mail account candidate whether the mail account candidates requested by the user have already been assigned to other users. If a mail account is unassigned, the server 210 decides to assign the mail account to the user. If all candidates have already been assigned, the server 210 requests the PC 160 at the mass sales store 16 to create another mail account candidate.

Upon deciding to assign the mail account requested by the user, the server 210 also decides the user ID, user password, and mail password for the user and transmits pieces of information necessary for Internet connection, including the above pieces of information, DNS, and access point, to the PC 160 at the mass sales store 16.

The PC 160 at the mass sales store 16 generates the Internet connection information 150 having a predetermined format, including the user ID, user password, mail password, DNS, and access point, on the basis of the information sent from the server 210 of the provider, and starts operation of encrypting the Internet connection information 150 using a media key Km (to be described later) in accordance with a prede-termined algorithm and writing the Internet connection information 150 in the storage area of the memory card 15 inserted to the card slot of the PC 160. The window is switched to an information writing window 206.

As shown in FIG. 3, the memory card 15 has a controller 30, and a storage medium section formed from a public area 31 and secret area 32.

The secret area 32 is a storage area that can be accessed only by a private procedure (i.e., specific secret procedure) through the controller 30 and has a secret ROM area 320 where a constant such as media identification information (to be referred to as a media key hereinafter) Km unique to the corresponding memory card 15 is stored. The media key Km only need be unique to each memory card 15, and various kinds of identification information such as a serial number, manufacturing number (manufacturing number or manufacturing lot number of each memory card 15) can be used. The secret ROM area 320 is ensured, e.g., on the ROM (Read only Memory).

The public area 31 is an area except the secret area, which can be accessed by a normal access, and has a rewritable public area (to be referred to as a public R/W area hereinafter) 310. The Internet connection information 150 encrypted by the media key Km is written to a predetermined position of the public R/W area 310. The public R/W area 310 is ensured, e.g., in specific area of a flash memory (rewritable nonvolatile memory).

When the Internet connection information 150 is completely written in the public R/W area 310, the PC 160 switches the window to an inquiry window 207 for inquiring the user whether the information on the memory card 15 need be protected by a password.

If the user requests protection by a password, the PC 160 makes the user to designate the password. The PC 160 encrypts the password designated by the user in accordance with a predetermined algorithm and writes it to a predetermined position in the public R/W area 310 of the memory card 15 as a password 311. The encrypted password 311 is used as a key to extract the media key Km from the secret ROM area 320. When the password 311 is completely written on the memory card 15, the PC 160 ends the series of Internet connection information write processing, i.e., user registration processing operations. In this case, the PC 160 switches the window to a window 208 representing completion of user registration and also notifies an agreement count server 211 of the enterprise (system providing company), which has developed this system, of completion of user registration through, e.g., the Internet, as indicated by an arrow c. If protection by a password is not requested, the PC 160 immediately switches the window to the user registration completion window 208 and notifies the agreement count server 211 of completion of user registration, as indicated by the arrow c. This user registration completion notification also contains the information of the provider that has made the agreement with the user.

The agreement count server 211 counts (totalizes) the numbers of users (the number of subscribers) having agreements with the providers in units of Internet connection information registration service stores such as the mass sales store 16. Upon receiving the user registration completion notification from the PC 160 at the mass sales store 16, the agreement count server 211 increments the number of subscribers to the provider of notification by one and increments the number of subscribers handled by the store (mass sales store 16) that has done the Internet connection information registration service for connection to the provider by one.

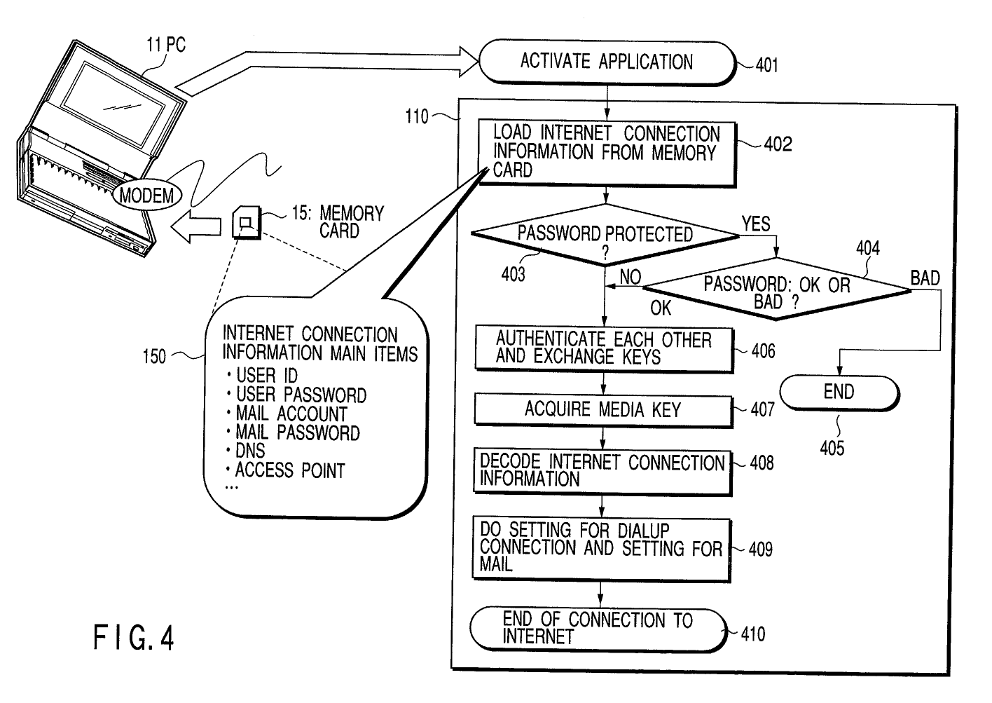

Internet connection by the user-side electronic device using the memory card 15 on which the Internet connection information 150 is written in the above-described way will be described next with reference to FIG. 4.

Assume that the user inserts the memory card 15 having the Internet connection information 150 written thereon into the memory card slot of the electronic device such as the PC 11, portable telephone 12, electronic camera 13, or TV apparatus 14 shown in FIG. 1. Assume that the electronic device is the PC 11, as shown in FIG. 4.

The PC 11 loads information from a predetermined position of the memory card 15. Information for activating the application 110 is written at this predetermined position of the memory card 15. Hence, when the PC 11 loads the information, the application 110 is activated (step 401).

The PC 11 operates in accordance with the application 110 in the following manner.

First, the PC 11 loads the Internet connection information 150 encrypted by the media key Km from the memory card 15 (from the public R/W area 310 of the memory card 15) (step 402). The PC 11 checks whether the Internet connection information 150 is protected by a password, i.e., the password 311 is registered on the memory card 15 (step 403).

If YES in step 403, the PC 11 causes the user to input the password. The PC 11 reads out the encrypted password 311 from the memory card 15 (from the public R/W area 310 of the memory card 15) and compares/ collates it with the password input by the user (step 404). In this case, the password 311 read out from the memory card 15 may be decrypted and collated with the password, or the input password may be encrypted and collated with the password 311 read out from the memory card 15. If the passwords do not match, the PC 11 determines that the user is not the authentic holder of the memory card 15 and ends the processing (step 405).

If the passwords match, the PC 11 determines that the user is the authentic holder of the memory card 15. In this case, the PC 11 and memory card 15 (the controller 30 of the memory card 15) authenticate each other in accordance with a known procedure to confirm that both parties are authentic, thereby exchanging keys and sharing a single authentication key (K×1) (step 406). This key exchange is done by, e-g., a method using random challenge response represented by a CSS (Content Scrambling System) used as a content encryption algorithm for a DVD-ROM. The authentication key (K×1) is a time-variant key that changes every time.

If NO in step 403, the PC 11 immediately advances to step 406 to perform mutual authentication and then key exchange to share a single authentication key (K×1).

When sharing the single authentication key (K×1) with the memory card 15, the PC 11 requests the memory card 15 (the controller 30 of the memory card 15) for the media key Km stored on the memory card 15 (in the secret ROM area 320 of the memory card 15). The controller 30 of the memory card 15 reads out the media key Km stored in the secret ROM area 320, encrypts the media key Km by the authentication key (K×1), and sends the encrypted media key Km (=K×1[Km]) to the PC 11.

upon receiving the encrypted media key Km (=K×1[Km]) sent from the memory card 15 (the controller 30 of the memory card 15), the PC 11 decrypts the media key Km using the authentication key (K×1) acquired by the preceding key exchange, thereby obtaining the media key Km (step 407). The procedure of obtaining the media key Km is also applied to a case wherein the PC 160 at the mass sales store 16 will acquire the media key Km to be used to encrypt the Internet connection information 150 from the provider server 210.

The PC 11 acquires the decrypted media key Km and decrypts, by the acquired media key Km, the Internet connection information 150 encrypted (by the media key Km) and loaded from the memory card 15 in step 402 (step 408). Thus, the PC 11 acquires the decrypted Internet connection information 150.

On the basis of the acquired Internet connection information 150, the PC 11 executes setting for dialup connection for connecting itself to the provider 18 (to the Internet 10 through the provider 18) and setting for mail on a predetermined area of a nonvolatile storage means such as a flash memory in accordance with the application 110 (step 409). With this processing, setting for connection to the Internet 10 is ended (step 410), so the user can access the Internet 10 from the PC 11. That is, setting for connection to the Internet 10 can be automatically done only by inserting the memory card 15 with the Internet connection information 150 written thereon into the card slot of the PC 11 by the user. Even for an electronic device other than the PC 11, e.g., the portable telephone 12, electronic camera 13, or TV apparatus 14 shown in FIG. 1, which has the card slot for the memory card 15 and the application 110 (stored or downloaded in advance), setting for connection to the Internet 10 can be automatically performed only by inserting the memory card 15 with the Internet connection information 150 written thereon into the card slot of the electronic device. In activating the application 110, it may be checked whether Internet connection setting has already been done, and if so, the Internet connection setting operation may be suppressed. For this purpose, flag information representing whether the Internet connection setting has already been done is set to a predetermined position of the nonvolatile storage means.

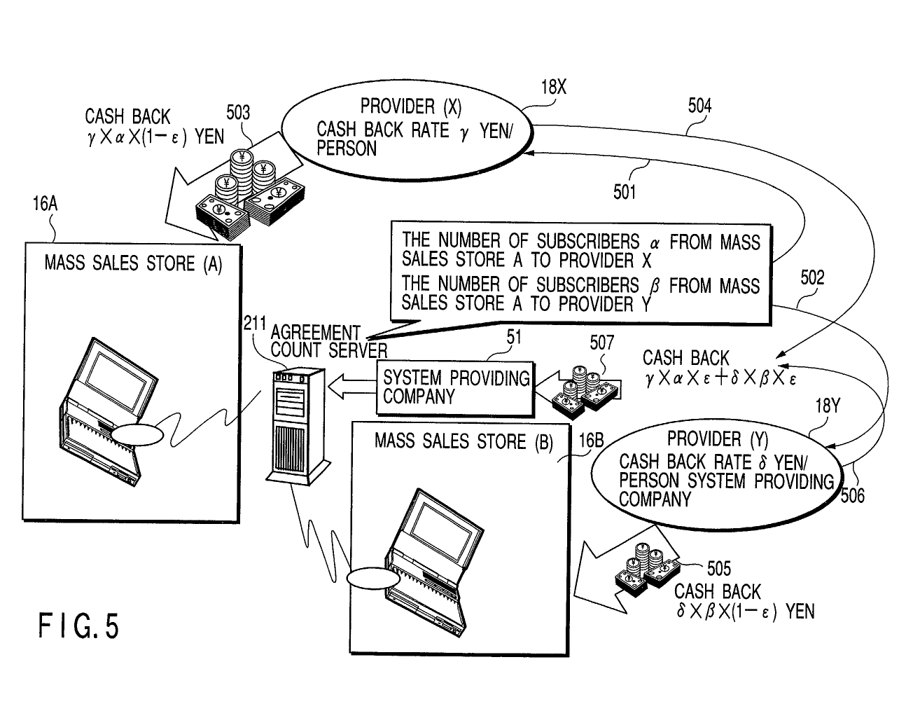

Finally, cash back from each provider 18 to the system providing company and Internet connection information registration service store will be described with reference to FIG. 5.

Assume that the providers 18 comprise two providers 18X and 18Y, the Internet connection information registration service store which has done the Internet connection information registration service with user subscription to the provider 18X comprises a mass sales store 16A, and the Internet connection information registration service store which has done the Internet connection information registration service with user subscription to the provider 18Y is a mass sales store 16B. Let γ be the total cash back rate per subscriber from the provider 18X to the Internet connection information registration service store (mass sales store 16A) and system providing company 51, and δ be the total cash back rate per subscriber from the provider 18Y. Let ε: (1−ε) be the ratio between cash back to the system providing company 51 and that to the Internet connection information registration service stores (mass sales stores 16A and 16B) for the cash back rates γ and δ from the providers 18X and 18Y.

The agreement count server 211 of the system providing company 51 holds count information representing the number of subscribers from each service store to each provider in units of Internet connection information registration service stores. This count information contains the number α of subscribers from, e.g., the mass sales store 16A to the provider 18X and the number β of subscribers from the mass sales store 16B to the provider 18Y.

The agreement count server 211 notifies each provider of the number of subscribers from each Internet connection information registration service store periodically, e.g., every month on the basis of the contents held by the server 211 itself. Hence, the provider 18X is notified that the number of subscribers from the mass sales store 16A is α (step 501), and the provider 18Y is notified that the number of subscribers from the mass sales store 16B is β (step 502).

The provider 18x makes cash back of γ×α×(1−ε) yen to the mass sales store 16A and cash back of γ×α×ε yen to the system providing company 51 (steps 503 and 504). On the other hand, the provider 18Y makes cash back of δ×β×(1−ε) yen to the mass sales store 16B and cash back of δ×β×ε yen to the system providing company 51 (steps 505 and 506). Hence, the system providing company 51 receives cash back of γ×α×ε+δ×β×ε yen (step 507).

In the above-described embodiment, a stamp-size memory card is used as a portable recording medium. However, the present invention is not limited to this, and a memory card having any other shape or a portable recording medium other than a memory card, such as a floppy disk or MD can also be used. If the Internet connection information need not be protected, the storage area of the portable recording medium need not always have the public area and the secret area where the media key Km is stored.

As has been described above in detail, according to the present invention, automatic setting for Internet connection using a portable recording medium can be implemented.

In addition, according to the present invention, a business by the Internet connection information registration service which allows automatic setting for Internet connection using a portable recording medium can be implemented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of an Internet connection information registration service, comprising the steps of:
performing a service for registering Internet connection information for Internet connection on a portable recording medium by a write terminal which is installed in a store and is capable of connecting the portable recording medium while the portable recording medium is being connected to the write terminal; and
obtaining a predetermined compensation for the store from a provider selected by a user.

2. A method according to claim 1, wherein a developer of the Internet connection information registration service also obtains a predetermined compensation from the provider selected by the user.

3. A method according to claim 2, further comprising the steps of
sending a notification representing completion of registration of the Internet connection information on the portable recording medium by the write terminal from the terminal to an agreement count apparatus of the Internet connection information registration service developer,
counting, by the agreement count apparatus, the number of subscribers to each provider in units of stores,
periodically sending a count result from the agreement count apparatus to a corresponding provider, and
on the basis of the sent count result, calculating the compensations to be acquired from the provider by each store and the Internet connection information registration service developer.

4. A method of an Internet connection information registration service, comprising the steps of:
receiving information necessary for Internet connection from a terminal of an Internet provider selected by a user at a write terminal which is installed in a store and is capable of connecting a portable recording medium;
generating Internet connection information for Internet connection on the basis of the received information; and
registering the Internet connection information on the portable recording medium by the write terminal, thereby obtaining a predetermined compensation for the store from the provider selected by the user.

5. A method according to claim 4, wherein a developer of the Internet connection information registration service also obtains a predetermined compensation from the provider selected by the user.

6. A method according to claim 5, further comprising the steps of
sending a notification representing completion of registration of the Internet connection information on the portable recording medium by the write terminal from the terminal to an agreement count apparatus of the Internet connection information registration service developer,
counting, by the agreement count apparatus, the number of subscribers to each provider in units of stores,
periodically sending a count result from the agreement count apparatus to a corresponding provider, and
on the basis of the sent count result, calculating the compensations to be acquired from the provider by each store and the Internet connection information registration service developer.

7. An Internet connection setting method using a portable recording medium, comprising the steps of:
receiving information necessary for Internet connection from a terminal of an Internet provider selected by a user at a write terminal which is installed in a store and is capable of connecting the portable recording medium;
generating Internet connection information for Internet connection on the basis of the received information and registering the Internet connection information on the portable recording medium;
when the portable recording medium having the Internet connection information registered thereon is connected to an electronic device in which an application program capable of automatically loading the Internet connection information is registered in advance, automatically activating the application program and loading the Internet connection information from the portable recording medium; and
executing, in the electronic device, connection setting for Internet connection on the basis of the loaded Internet connection information.

8. A method according to claim 7, wherein
the registration step comprises the steps of
inputting an arbitrary password for protecting the Internet connection information to the write terminal, and
encrypting the input password in accordance with a predetermined algorithm and registering the encrypted password in a predetermined area of the portable recording medium, and
the execution step comprises the steps of
causing the user to perform operation of inputting a password in Internet connection setting in the electronic device,
executing predetermined processing for the input password and comparing/collating the input password which has undergone the predetermined processing with the encrypted registered password on the predetermined area, thereby determining authenticity of the user, and
executing the Internet connection setting on the basis of a determination result.

9. An Internet connection setting method for an electronic device capable of connecting a portable recording medium, comprising the steps of:
when the portable recording medium having Internet connection information of an Internet provider selected by a user at a write terminal installed in a store is connected to the electronic device, automatically activating a predetermined application program for Internet connection setting; and
loading the Internet connection information from the portable recording medium in accordance with the application program and executing, in the electronic device, connection setting for Internet connection on the basis of the Internet connection information.

10. A method according to claim 9, wherein
the execution step comprises the steps of
if a password input by the user who has selected the Internet provide is registered on the portable recording medium, causing the user to perform operation of inputting a password,
determining authenticity of the user by comparing/collating the input password with the registered password, and
executing the Internet connection setting on the basis of a determination result.

11. A method according to claim 9, wherein the Internet connection setting is dialup connection setting based on the Internet connection information.

12. An Internet connection information registration method at a write terminal for an Internet connection service, which is capable of connecting a portable recording medium, comprising the steps of:
causing a user to perform operation of selecting a desired Internet provider;
inputting information necessary for a provider agreement with the Internet provider selected by the user operation;
transmitting the input information to a terminal of the selected Internet provider through a communication line, thereby receiving information necessary for Internet connection from the provider terminal; and
generating Internet connection information for Internet connection on the basis of the received information and registering the generated Internet connection information on the portable recording medium connected to the write terminal.

13. A method according to claim 12, wherein
the input information contains at least one of a method of paying a charge to the Internet provider selected by the user and a candidate of a mail account requested by the user, and
the Internet connection information is information for dialup connection.

14. A computer-readable recording medium which records an Internet connection setting application program, comprising:
means, activated when a portable recording medium is connected to an electronic device, for loading Internet connection information for Internet connection from the portable recording medium when the Internet connection information is registered on the portable recording medium; and
means for performing connection setting for Internet connection in the electronic device on the basis of the Internet connection information loaded from the portable recording medium.

15. A computer-readable recording medium which records an Internet connection setting application program, comprising:
means, activated when a portable recording medium having a secret area accessible only by a private procedure, where media identification information unique to the portable recording medium is stored, and a public area which can be arbitrarily externally accessed is connected to an electronic device capable of connecting the portable recording media, for loading Internet connection information for Internet connection, which is encrypted by the media identification information, from the portable recording medium when the Internet connection information is registered on the portable recording medium;
means for performing mutual authentication with the portable recording medium and exchanging authentication keys;
means for acquiring the media identification information encrypted by the authentication key from the portable recording medium;
means for decrypting the acquired media identification information by the authentication key and decrypting the encrypted Internet connection information loaded from the portable recording medium using the decrypted media identification information; and
means for executing a step of executing connection setting for Internet connection in the electronic device on the basis of the decrypted Internet connection information.

16. A medium according to claim 15, further comprising
means for checking whether a password encrypted by a predetermined algorithm is registered in the public area of the portable recording medium,
means for, when the password is registered, causing a user to input a password, executing predetermined processing for the input password, and comparing and collating the password which has undergone the predetermined processing with the password registered in the public area, and
means for ending processing when mismatching between the passwords is detected by the comparison and collation.

17. A computer-readable recording medium which records an Internet connection information registration application program for providing a user service for registering Internet connection information for Internet connection on a portable recording medium, comprising:
means for causing a user to perform operation of selecting a desired Internet provider;
means for receiving information necessary for Internet connection from a terminal of the Internet provider selected by the user operation; and
means for generating Internet connection information for Internet connection on the basis of the received information and registering the Internet connection information on the portable recording medium.

18. A computer-readable recording medium which records an Internet connection information registration application program for providing a user service for registering Internet connection information for Internet connection on a portable recording medium having a secret area accessible only by a private procedure, where media identification information unique to the portable recording medium is stored, and a public area which can be arbitrarily externally accessed, comprising:
means for causing a user to perform operation of selecting a desired Internet provider;
means for receiving information necessary for Internet connection from a terminal of the Internet provider selected by the user operation;
means for performing mutual authentication with the portable recording medium and exchanging authentication keys while the portable recording medium is being connected to a write terminal;
means for acquiring the media identification information encrypted by the authentication key from the portable recording medium; and
means for, while the acquired media identification information is decrypted by the authentication key, generating Internet connection information for Internet connection on the basis of the received information, encrypting the Internet connection information by the decrypted media identification information, and registering the Internet connection information on the portable recording medium.

19. A medium according to claim 18, further comprising
means for inquiring a user whether the Internet connection information need be protected by a password, and
means for, when protection by the password is requested, causing the user to perform operation of inputting an arbitrary password, encrypting the input password in accordance with a predetermined algorithm, and registering the encrypted password in the public area of the portable recording medium as a key for acquiring the media identification information from the secret area of the portable recording medium.

20. An Internet connection information write terminal for providing a user service for registering Internet connection information for Internet connection on a connected portable recording medium, comprising:
provider list window display means for displaying a provider list window for causing a user of the portable recording medium to perform operation of selecting a desired Internet provider;
information acquisition means for acquiring information necessary for Internet connection from a terminal of the Internet provider selected by the user operation on the provider list window; and
Internet connection information registration means for generating Internet connection information for Internet connection on the basis of the acquired information and registering the Internet connection information on the portable recording medium.

21. A terminal according to claim 20, further comprising registration completion notification means for sending a notification representing completion of registration by said Internet connection information registration means to an agreement count apparatus for counting the number of subscribers to each provider on the provider list window in units of stores where said Internet connection information write terminal is installed.
